(19) United States
(12) Patent Application Publication
(10) Pub. No.: US 2010/0215216 A1
(43) Pub. Date: Aug. 26, 2010

(54) Localization system and method

(75) Inventors: Jun Pyo Hong, Suwon-si (KR); Kyung Hwan Yoo, Incheon-si (KR); Jae Man Joo, Suwon-si (KR); Dong Won Kim, Hwaseong-si (KR); Woo Bam Chung, Seoul (KR); Jae Yong Jung, Suwon-si (KR); Hwi Chan Jang, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/659,078

(22) Filed: Feb. 24, 2010

Related U.S. Application Data
(60) Provisional application No. 61/155,295, filed on Feb. 25, 2009.

(30) Foreign Application Priority Data
Apr. 29, 2009 (KR) 10-2009-37400

(51) Int. Cl. G06K 9/62

(52) U.S. Cl. 382/103

(57) ABSTRACT

Disclosed herein is a localization system and method to recognize the location of an autonomous mobile platform. In order to recognize the location of the autonomous mobile platform, a beacon (three-dimensional structure) having a recognizable image pattern is disposed at a location desired by a user, the mobile platform which knows image pattern information of the beacon photographs the image of the beacon and finds and analyzes a pattern to be recognized from the photographed image. A relative distance and a relative angle of the mobile platform are computed using the analysis of the pattern such that the location of the mobile platform is accurately recognized.

### CROSS-REFERENCE TO RELATED APPLICATIONS

This application claims the benefit of U.S. Patent Application No.: 61/155,295, filed on Feb. 25, 2009 in the U.S. Patent and Trademark Office and Korean Patent Application No. 10-2009-37400, filed on Apr. 29, 2009 in the Korean Intellectual Property Office, the disclosures of which are incorporated herein by reference.

### BACKGROUND OF THE INVENTION

1. Field of the Invention

Embodiments relate to a localization system and method to recognize the location of an autonomous mobile platform using image information of a beacon (three-dimensional structure) having a recognizable pattern.

2. Description of the Related Art

As artificial intelligence type unmanned technology has been developed, considerable research into self-localization technology has been conducted. Conventionally, localization technology using inertial navigation was used for aircraft or missiles. As a Global Positioning System (GPS) using an artificial satellite is commercialized, the localization technology is used in various fields. In addition, the localization technology commercially provides an enormous added value. However, since the localization technology does not achieve good performance in a building or a downtown area yet, considerable research into a solution for achieving good performance even in any place has been conducted. Recently, as a localization technology is introduced into mobile products available in a room, it is expected that various functions and an added value thereof may be obtained.

For example, recently, in order to autonomously move a robot (a domestic assistant robot, a service robot of a public place, a transportation robot of a production place, an operator assistant robot or the like) available in various fields, the robot recognizes its location without information about its environment and simultaneously performs a localization and map-building process to build a map using the information about the environment.

Conventionally, a method of fixing or movably mounting a location information transmission device (beacon) separated from a robot at a specific location of a room (or a building) such that the robot receives a signal transmitted from the location information transmission device and detecting the relative location of the robot with respect to the location information transmission device was widely used.

However, in the fixed location information transmission device, if necessary, a user moves the location information transmission device, in order to accurately recognize the location of the robot. In the movable location information transmission device, the location information transmission device may be moved, but a battery is used as a power supply necessary for transmitting a signal.

### SUMMARY OF THE INVENTION

Therefore, it is an aspect to provide a localization system and method to accurately recognize the relative location of a mobile platform using image information of a beacon (three-dimensional structure) having a recognizable pattern.

Additional aspects of the invention will be set forth in part in the description which follows and, in part, will be apparent from the description, or may be learned by practice of the invention.

The foregoing and/or other aspects are achieved by providing a localization system includes a beacon having a recognizable image pattern, and a mobile platform, the location of which is recognized using the image pattern of the beacon.

The beacon may be a polygonal structure disposed to be separated from the mobile platform.

The polygonal structure may have at least two sides, and one or more recognizable image patterns may be printed on the sides.

The image patterns printed on the sides may be equal to or different from each other.

The mobile platform may include an image acquisition unit photographing the beacon and acquiring single image information of the beacon, and a controller analyzing the acquired single image information and acquiring coordinate information of the location of the mobile platform.

The acquired coordinate information may include a relative distance and a relative angle of the mobile platform with respect to the beacon.

The controller may measure the height of the recognized pattern in the photographed image and compute the relative distance.

The controller may measure the width of the recognized pattern in the photographed image and compute the relative angle.

If one side of the polygonal structure is viewed in the photographed image, the controller may compare the heights of the right and left portions of the recognized pattern and compute the relative angle of the mobile platform with respect to the beacon.

If two sides of the polygonal structure are viewed in the photographed image, the controller may compute the relative angle of the mobile platform with respect to the beacon using a ratio of the widths of the two recognized patterns.

The mobile platform may further include a storage unit to store geometrical information of the image patterns printed on the sides of the polygonal structure.

The mobile platform may perform an operation in a specific region in which the mobile platform is located with respect to the beacon.

The beacon may be a polygonal structure attached to the mobile platform.

The localization system may further include an image acquisition unit photographing the beacon and acquiring single image information of the beacon, and the image acquisition unit may be disposed to be separated from the mobile platform.

The mobile platform may further include a controller analyzing the acquired single image information and acquiring coordinate information of the location of the mobile platform.

The localization system may further include a communication unit to transmit the acquired single image information to the mobile platform, and the communication unit may transmit any one of an audible frequency signal, an ultrasonic wave, visible light, infrared light, a laser beam, a Radio Frequency (RF) signal.

The foregoing and/or other aspects are achieved by providing a localization method includes photographing a beacon having a recognizable image pattern and recognizing the image pattern of the beacon, retrieving candidate patterns from the recognized image pattern using a mask pattern, extracting a normal pattern from the retrieved candidate patterns using a check pattern, computing a relative distance and a relative angle of a mobile platform with respect to the beacon using size information of the extracted pattern, and recognizing the location of the mobile platform using the computed relative distance and relative angle.

The size information may include height information of the center of the pattern, vertex information of the right and left portions of the pattern, and width information of the right and left portions of the pattern.

The localization method may further include determining the number of sides of the extracted pattern, and the computing of the relative distance and the relative angle may include computing the relative distance using the height of the center of the pattern and computing the relative angle by comparing the heights of the right and left portions of the pattern.

The localization method may further include determining the number of sides of the extracted pattern, and the computing of the relative distance and the relative angle may include computing the relative distance using the height of the center of the pattern and computing the relative angle using a ratio of the widths of the right and left portions of the pattern.

According to the embodiments, in order to recognize the location of an autonomous mobile platform, a beacon (three-dimensional structure) having a recognizable image pattern is disposed at a location desired by a user, the mobile platform which knows pattern information of the beacon photographs the image of the beacon, analyzes the photographed image pattern, and computes a relative distance and a relative angle of the mobile platform according to the analyzed result, such that the location of the mobile platform is accurately recognized.

### BRIEF DESCRIPTION OF THE DRAWINGS

These and/or other aspects will become apparent and more readily appreciated from the following description of the embodiments, taken in conjunction with the accompanying drawings of which:

FIG. 1 is a diagram showing the overall configuration of a localization system according to an embodiment;

FIG. 2 is a control block diagram of a mobile platform according to the embodiment;

FIG. 3 is a view showing three-dimensional information of a beacon in the localization system according to the embodiment;

FIG. 4 is a conceptual diagram explaining an operation principle of the localization system according to the embodiment in a space;

FIG. 5 is a conceptual diagram explaining the operation principle of the localization system according to the embodiment on a plane;

FIG. 6 is a flowchart illustrating a method of matching an image pattern of the beacon and recognizing the location of a mobile platform according to the embodiment;

FIG. 7 is a view showing a mask pattern used in the matching of the pattern of FIG. 6;

FIGS. 8A and 8B are views explaining a process of computing a distance from the mobile platform to the beacon, according to the embodiment;

FIG. 9 is a view showing the image of the beacon displayed on a camera screen of an image acquisition unit according to the embodiment;

FIG. 10 is a view explaining a process of computing the relative angle of the mobile platform with respect to the beacon, both sides of which are viewed, in the localization system according to the embodiment;

FIGS. 11A and 11B are views explaining a process of computing the relative angle of the mobile platform with respect to the beacon, one side of which is viewed, in the localization system according to the embodiment; and

FIGS. 12A, 12B, 13A, 13B, 14A, 14B, 15A and 15B are views showing window images to recognize the location of the mobile platform using the localization system according to the embodiment.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout.

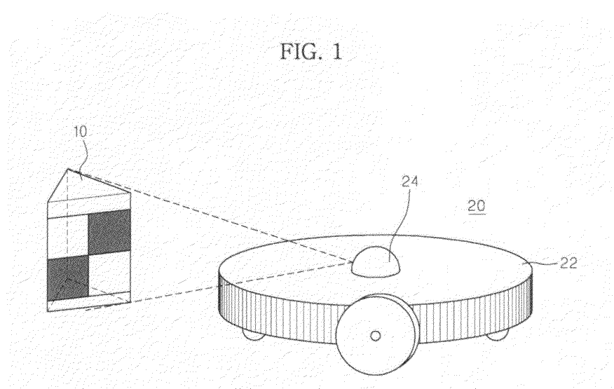

FIG. 1 is a diagram showing the overall configuration of a localization system according to an embodiment. The localization system includes a movable beacon 10 having an image recognition pattern, and a mobile platform 20 to remotely photograph the beacon 10 while autonomously moving and recognize its location.

The beacon 10 is a three-dimensional structure which is disposed to be separated from or coupled to the mobile platform 20 at a location desired by a user, such as a polygonal structure (e.g., a triangular prism, a cube or the like) having at least two sides a and b. One or more geometrical image patterns is printed on the sides a and b of the polygonal structure, and the image patterns printed on the sides a and b are identical to or different from each other.

The mobile platform 20 includes a movable robot main body 22 and an image acquisition unit 24 mounted on the robot main body 22, and remotely photographs the beacon 10 in a state of knowing geometrical image pattern information of the beacon 10, geometrically analyzes the photographed image pattern, and recognizes its location.

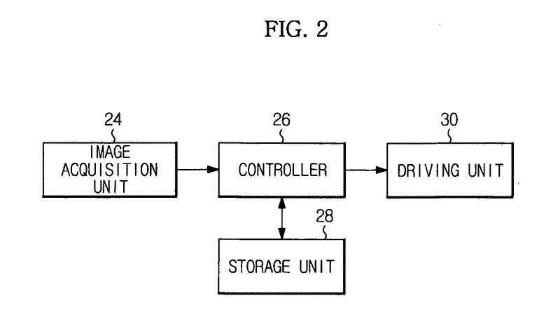

FIG. 2 is a control block diagram of the mobile platform according to the embodiment. The mobile platform includes an image acquisition unit 24, a controller 26, a storage unit 28 and a driving unit 30.

The image acquisition unit 24 is a three-dimensional measurement device (e.g., a stereo camera, a time-of-flight camera or the like) to remotely photograph the beacon 10 (three-dimensional structure) located on a path on which the mobile platform 20 moves in an unknown environment and acquire the image information (height and width information of the geometrical image pattern) of the beacon 10. The three-dimensional measurement device acquires the image information of the beacon 10 using pixels of the camera and acquires distance information of the beacon 10 detected by a sensor and the pixels, such that such information is utilized in localization or obstacle detection.

The controller 26 receives the image information (height and width information of the geometrical image pattern) acquired by the image acquisition unit 24 and obtains coordinate information of the location of the mobile platform 20. The controller 26 is a Central Processing Unit (CPU) to measure the height and the width of the geometrical image pattern from the image information acquired by the image acquisition unit 24, compute the relative distance and the relative angle of the mobile platform 20 using the measured height and the width of the image pattern, and recognize the location of the mobile platform 20.

The storage unit 28 is a memory to store the pattern information (height and width information of the geometrical image pattern) printed on the sides a and b of the beacon 10 and the information about the beacon 10 (height and width information of the beacon). A current location and a final target location of the mobile platform 20 are stored in the storage unit.

The driving unit 30 drives the mobile platform 20 to be autonomously moved on the path without collision with a wall or an obstacle, based on the location information recognized by the controller 26.

Hereinafter, the operation and effects of the localization system having the above-described configuration and the method thereof will be described.

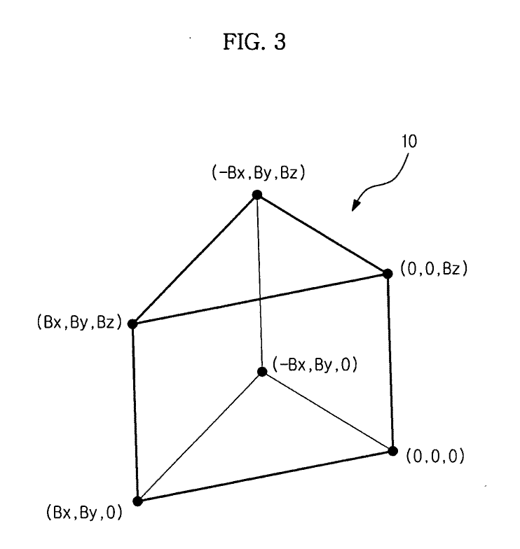

FIG. 3 is a view showing three-dimensional information of the beacon in the localization system according to the embodiment, which shows coordinate information of the beacon 10 on a three-dimensional space.

In FIG. 3, Bx and By respectively denote the X- and Y-axis sizes of the beacon 10 and Bz denotes the height of the beacon 10.

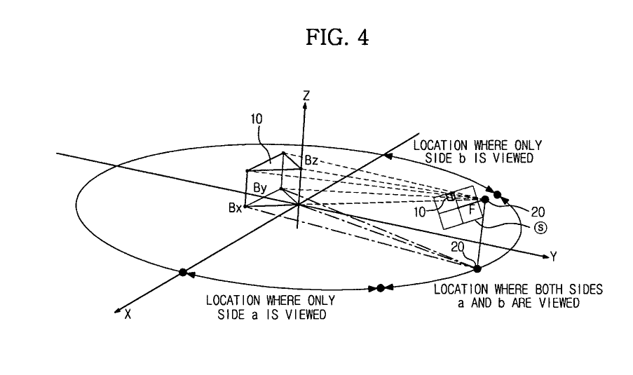

FIG. 4 is a conceptual diagram explaining an operation principle of the localization system according to the embodiment in a space.

As shown in FIG. 4, the mobile platform 20 photographs the beacon 10 having the recognizable image pattern using the image acquisition unit 24 attached thereto. The image information obtained by photographing the beacon 10 may be changed according to the location of the mobile platform 20.

That is, in a state in which the beacon 10 including the polygonal structure having the two sides a and b is fixed, the image of the beacon 10 photographed using the image acquisition unit 24 may contain only one side a or b or may contain both sides a and b, according to the movement of the mobile platform 20.

In FIG. 4, ‘S’ denotes the shape of the beacon 10 displayed on the camera screen of the image acquisition unit 24 and F denotes a focus distance.

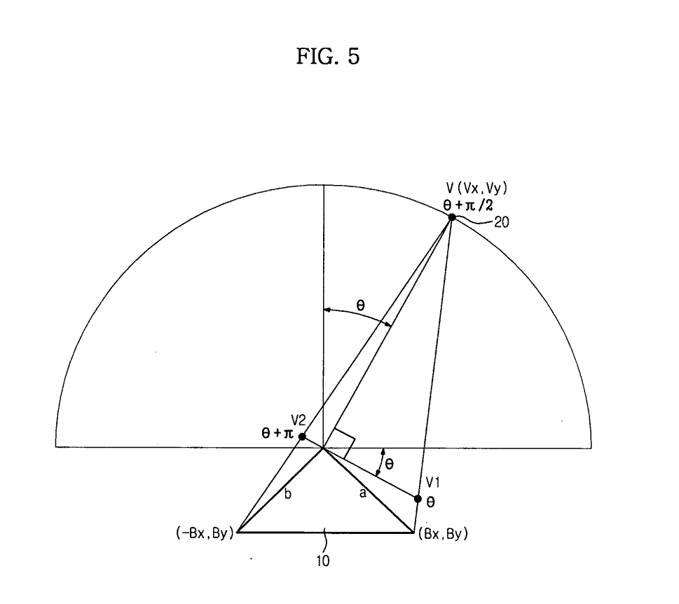

FIG. 5 is a conceptual diagram explaining the operation principle of the localization system according to the embodiment on a plane.

In FIG. 5, the beacon 10 is the triangular prism in which the recognizable patterns are printed on the two sides a and b thereof. The patterns printed on the two sides a and b are different from each other. The mobile platform 20 knows the geometrical information (height and width information) of the image patterns printed on the two sides a and b in advance.

The image acquisition unit 24 attached to the mobile platform 20 in order to photograph the image of the beacon 10 located in an environment, in which the mobile platform 20 is moved, finds the image pattern to be recognized from the photographed image information and sends the image pattern to the controller 26.

At this time, since the height of the recognized image pattern seems to be changed according to the distance, the controller 26 computes the relative distance from the mobile platform 20 to the beacon 10. In addition, since the width of the recognized image pattern seems to be changed according to viewing angle, the controller 26 computes the relative angle of the mobile platform 20 with respect to the beacon 10.

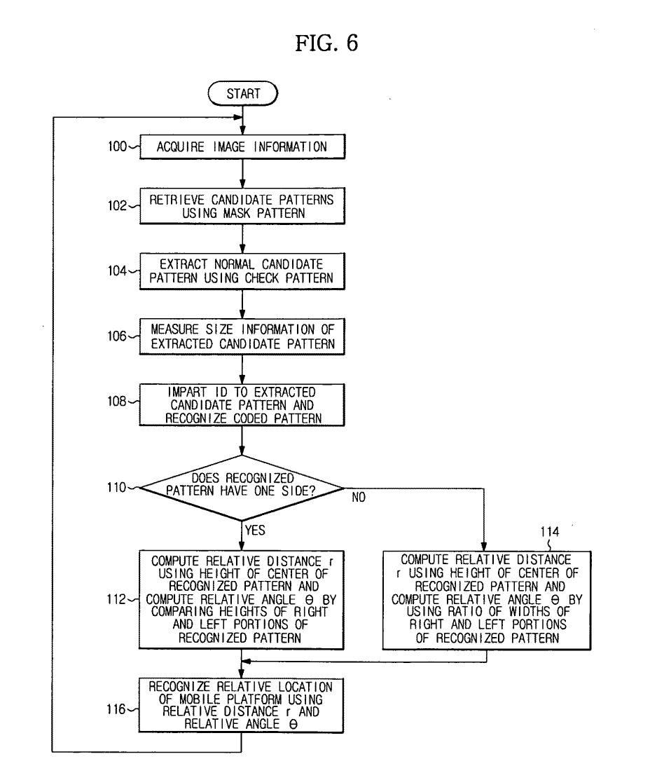

Accordingly, the controller 26 detects the relative distance from the mobile platform 20 to the beacon 10 and the relative angle of the mobile platform 20, that is, the relative location of the mobile platform 20 with respect to the beacon 10 using a two-dimensional pattern. This will be described with reference to FIG. 6.

FIG. 6 is a flowchart illustrating a method of matching the image pattern of the beacon and recognizing the location of the mobile platform according to the embodiment.

In FIG. 6, the image acquisition unit 24 photographs the image of the beacon 10 located on the path on which the mobile platform 20 moves, and acquires the image information (100).

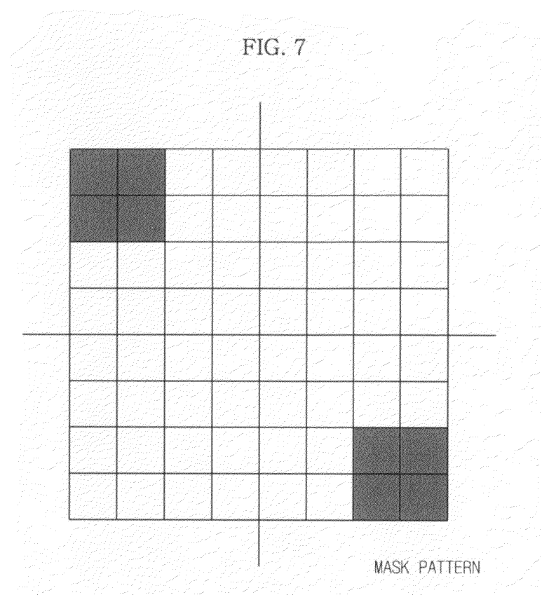

The image information acquired using the image acquisition unit 24 is input to the controller 26. The controller 26 retrieves candidate patterns using a mask pattern shown in FIG. 7 from the geometrical image pattern of the acquired image information (102). The method of retrieving the candidate patterns using the mask pattern is performed by matching the acquired image pattern with the mask pattern.

If the candidate patterns are retrieved using the mask pattern, the controller 26 checks a pattern error of the retrieved candidate patterns using a check pattern stored in advance in order to determine whether the retrieved candidate patterns are normal or abnormal, and extracts only a normal pattern from the retrieved candidate patterns (104).

If the normal candidate pattern is extracted using the check pattern, the controller 26 measures size information (e.g., height information of the center of the pattern, vertex information of the right and left portions of the pattern, width information of the right and left portions of the pattern or the like) of the extracted candidate pattern (normal candidate pattern) (106), imparts an identification (ID) to the extracted candidate pattern (normal candidate pattern), and recognizes a coded pattern (108).

Thereafter, it is determined whether the recognized pattern has one side (110). If it is determined that the recognized pattern has one side a or b, a relative distance r is computed using the height of the center of the recognized pattern, and the relative angle θ is computed by comparing the vertex information of the right and left portions of the recognized pattern, that is, the heights of the right and left portions (112).

If is determined that the recognized pattern has two sides a and b in Operation 110, the relative distance r is computed using the height of the center of the recognized pattern, and the relative angle θ is computed using the width information of the right and left portions of the recognized pattern, that is, a ratio of the widths of the right and left portions (114).

The relative location (x, y, Ψ) of the mobile platform 20 is detected using the relative distance r and the relative angle θ computed according to the side viewed in the recognized image pattern (116).

Since the recognition degree of the image pattern is changed according to the resolution of the image acquisition unit 24, the angle of the recognized image pattern may be more accurately computed if a three-dimensional structure is used. As shown in FIG. 5, if the patterns printed on two inclined sides of the triangular prism are viewed, the mobile platform 20 checks how many the patterns are tilted from a central line of an isosceles triangle so as to more accurately detect the relative angle of the mobile platform 20 with respect to the beacon 10. Accordingly, the image pattern may be applied if accurate alignment such as docking is necessary.

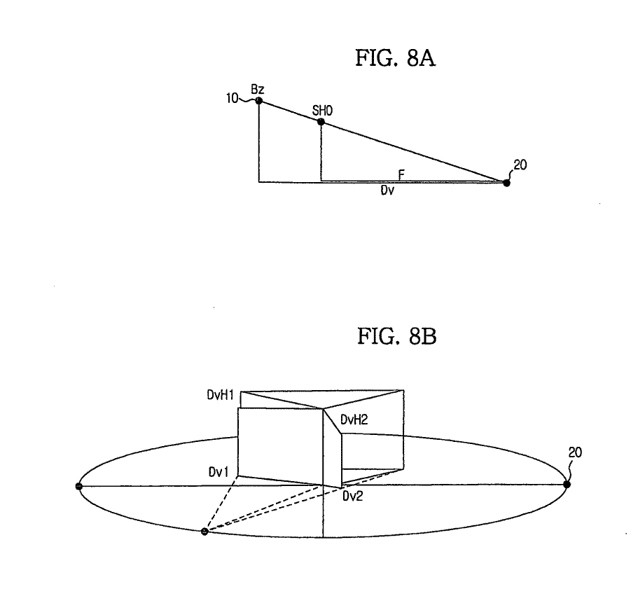

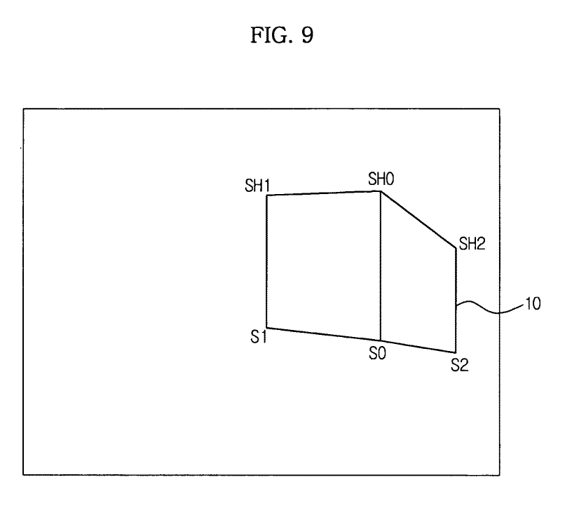

FIGS. 8A and 8B are views explaining a process of computing a distance from the mobile platform to the beacon, according to the embodiment. FIG. 9 is a view showing the image of the beacon displayed on the camera screen of the image acquisition unit according to the embodiment.

In FIGS. 8A and 8B, Dv denotes the distance from the mobile platform 20 to the beacon 10, Bz denotes the height of the beacon 10 when the distance from the mobile platform 20 to the beacon 10 is Dv, F denotes the distance from the mobile platform 20 to a focus, SHO denotes the height of the beacon 10 when the distance from the mobile platform 20 to the focus is F.

Accordingly, the distance Dv from the mobile platform 20 to the beacon 10 may be expressed by Equation 1.

F: SH0=Dv: Bz

Dv→BzF/SH0 Equation 1

In FIG. 9, the ratios of SH1, SH2, S1 and S2 to an overlapping area SHO in the image of the beacon 10 may be expressed by Equation 2.

Ratio1→S1/SH0

Ratio2→S2/SH0

RatioH1→SH1/SH0

RatioH2→SH2/SH0 Equation 2

In addition, if the height of the overlapping region SH0 in the image of the beacon 10 is set as an actual height of the beacon 10, the distances of the points are computed as expressed by Equation 3.

Dv1→Ratio1×Bz

Dv2→Ratio2×Bz

DvH1→RatioH1×Bz

DvH2→RatioH2×Bz Equation 3

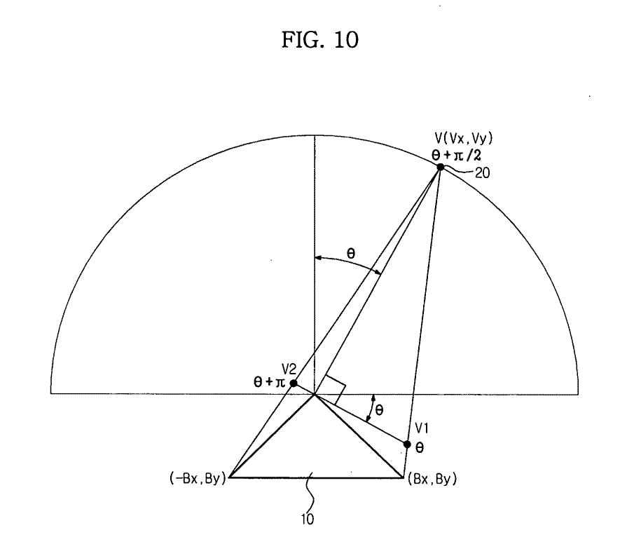

FIG. 10 is a view explaining a process of computing the relative angle of the mobile platform with respect to the beacon in the localization system according to the embodiment. The relative angle of the mobile platform 20 is computed at a location where both sides a and b are viewed.

In FIG. 10, respective straight lines from V1, V and V2 to an original point may be expressed by Equation 4.

$$V 1 \to ( V 1 x = Dv 1 Cos [ θ ] , V 1 y = Dv 1 Sin [ θ ] ) \\ V \to ( Vx = Dv Cos [ θ + \frac{π}{2} ] , Vy = Dv Sin [ θ + \frac{π}{2} ] ) \\ V \to ( Vx = - Dv Sin [ θ ] , Vy = Dv Cos [ θ ] ) \\ V 2 \to ( \begin{matrix}V 2 x = Dv 2 Cos [ θ + π ] , \\ V 2 y = Dv 2 Sin [ θ + π ]\end{matrix} ) \\ V2 \to ( V 2 x = - Dv 2 Cos [ θ ] , V 2 y = - Dv 2 Sin [ θ ] ) \qquad Equation 4$$

In addition, a straight line passing through V and V1 and a straight line passing through V and V2 may be expressed by Equation 5.

$$\frac{V 1 y - By}{V 1 x - Bx} = \frac{Vy - By}{Vx - Bx} \\ \frac{V 2 y - By}{V 2 x + Bx} = \frac{Vy - By}{Vx - Bx} \\ V 1 y = \frac{Vy - By}{Vx - Bx} ( V 1 x - Bx ) + By \\ V 2 y = \frac{Vy - By}{Vx + Bx} ( V 2 x + Bx ) + By \qquad Equation 5$$

The values cos(θ) and sin(θ) of Equation 4 may be obtained by Equation 6.

$$- DvDv 1 + ( BxDv + ByDv 1 ) Cos [ θ ] + ( ByDv - BxDv 1 ) Sin [ θ ] = 0 \\ DvDv 2 + ( BxDv + ByDv 2 ) Cos [ θ ] + ( ByDv - BxDv 2 ) Sin [ θ ] = 0 \\ Cos [ θ ] \to \frac{Dv ( 2 BxDv 1 Dv 2 - ByDv ( Dv 1 + Dv 2 ) )}{\begin{matrix}{Bx}^{2} Dv ( Dv 1 + Dv 2 ) - \\ {By}^{2} Dv ( Dv 1 + Dv 2 ) - 2 BxBy ( {Dv}^{2} - Dv 1 Dv 2 )\end{matrix}} \\ Sin [ θ ] \to \frac{{BxDv}^{2} ( - Dv 1 + Dv 2 )}{\begin{matrix}{Bx}^{2} Dv ( Dv 1 + Dv 2 ) - \\ {By}^{2} Dv ( Dv 1 + Dv 2 ) - 2 BxBy ( {Dv}^{2} - Dv 1 Dv 2 )\end{matrix}} \\ \qquad Equation 6$$

Accordingly, the relative angle V of the mobile platform 20 with respect to the beacon 10, both sides of which are viewed, may be expressed by Equation 7.

$$Vx \to \frac{{BxDv}^{3} ( - Dv 1 + Dv 2 )}{\begin{matrix}{Bx}^{2} Dv ( Dv 1 + Dv 2 ) - {By}^{2} Dv ( Dv 1 + Dv 2 ) - \\ 2 BxBy ( {Dv}^{2} - Dv 1 Dv 2 )\end{matrix}} \\ Vy \to \frac{{Dv}^{2} ( 2 BxDv 1 Dv 2 - ByDv ( Dv 1 + Dv 2 ) )}{\begin{matrix}{Bx}^{2} Dv ( Dv 1 + Dv 2 ) - {By}^{2} Dv ( Dv 1 + Dv 2 ) - \\ 2 BxBy ( {Dv}^{2} - Dv 1 Dv 2 )\end{matrix}} \qquad Equation 7$$

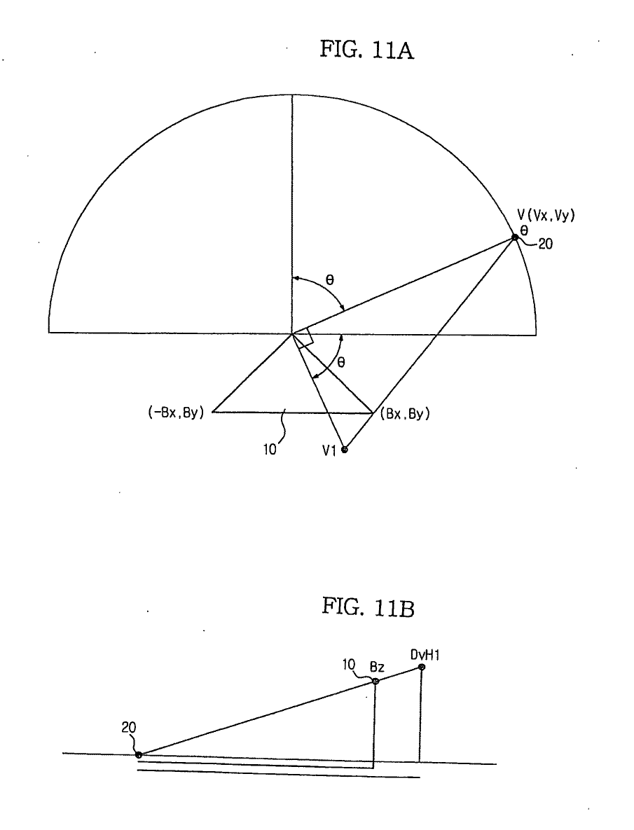

FIGS. 11A and 11B are views explaining a process of computing the relative angle of the mobile platform with respect to the beacon in the localization system according to the embodiment. The relative angle of the mobile platform 20 is computed at a location where only one side a or b is viewed.

In FIGS. 11A and 11B, the respective straight lines from V1 and V2 to the original point may be expressed by Equation 8.

V1→(V1x=Dv1 Cos [θ], V1y=Dv1 Sin [θ])

V→(Vx=−Dv Sin [θ], Vy=Dv Cos [θ])

A straight line passing through V, V1 and (Bx, By) may be expressed by Equation 9.

$$By = \frac{V 1 y - Vy}{V 1 x - Vx} ( Bx - Vx ) + Vy \qquad Equation 9$$

In Equation 9, the distance DvH1 from V to V1 and the distance Bz from the beacon 10 to V may be expressed by Equation 10.

$$\frac{DvH 1}{Bz} = \frac{\sqrt{{( V 1 x - Vx )}^{2} + {( V 1 y - Vy )}^{2}}}{\sqrt{{( Bx - Vx )}^{2} + {( By - Vy )}^{2}}} \qquad Equation 10$$

The values of cos(θ) and sin(θ) of Equation 8 may be obtained by Equation 11.

$$- ( {Dv}^{2} + Dv {1}^{2} ) {Bz}^{2} + DvH {1}^{2} ( {Bx}^{2} + {Dv}^{2} - 2 ByDv Cos [ θ ] + 2 BxDv Sin [ θ ] ) = 0 \\ - DvDv 1 + ( BxDv + ByDv 1 ) Cos [ θ ] + ( ByDv - BxDv 1 ) Sin [ θ ] = 0 \\ Cos [ θ ] = \frac{\begin{matrix}- {Bz}^{2} ( ByDv - BxDv 1 ) ( {Dv}^{2} + Dv {1}^{2} ) + \\ ( ByDv ( {Bx}^{2} + {By}^{2} + {Dv}^{2} ) - \\ Bx ( {Bx}^{2} + {By}^{2} - {Dv}^{2} ) Dv 1 ) DvH {1}^{2}\end{matrix}}{2 ( {Bx}^{2} + {By}^{2} ) {Dv}^{2} DvH {1}^{2}} \\ Sin [ θ ] = \frac{{Bz}^{2} ( BxDv + ByDv 1 ) ( {Dv}^{2} + Dv {1}^{2} ) - ( BxDv ( {Bx}^{2} + {By}^{2} + {Dv}^{2} ) + By ( {Bx}^{2} + {By}^{2} - {Dv}^{2} ) Dv 1 ) DvH {1}^{2}}{2 ( {Bx}^{2} + {By}^{2} ) {Dv}^{2} DvH {1}^{2}} \qquad Equation 11$$

Accordingly, the relative angle V of the mobile platform 20 with respect to the beacon 10, only one side of which is viewed, may be expressed by Equation 12.

$$V \to \frac{\begin{matrix}- {Bz}^{2} ( BxDv + ByDv 1 ) ( {Dv}^{2} + Dv {1}^{2} ) + \\ ( BxDv ( {Bx}^{2} + {By}^{2} + {Dv}^{2} ) + \\ By ( {Bx}^{2} + {By}^{2} - {Dv}^{2} ) Dv 1 ) DvH {1}^{2}\end{matrix}}{( 2 ( {Bx}^{2} + {By}^{2} ) {Dv}^{2} DvH {1}^{2} )} \\ Vy \to \frac{\begin{matrix}{Bz}^{2} ( - ByDv + BxDv 1 ) ( {Dv}^{2} + Dv {1}^{2} ) + \\ ( ByDv ( {Bx}^{2} + {By}^{2} + {Dv}^{2} ) - \\ Bx ( {Bx}^{2} + {By}^{2} - {Dv}^{2} ) Dv 1 ) DvH {1}^{2}\end{matrix}}{2 ( {Bx}^{2} + {By}^{2} ) DvDvH {1}^{2}} \qquad Equation 12$$

The relative distance and the relative angle of the mobile platform 20 using Equation 1 to Equation 12 may be expressed by Equation 13 to Equation 15.

The distance Dist from the mobile platform 20 to the beacon 10 is expressed by Equation 13.

$$Dist = \frac{BzF}{SH0} \qquad Equation 13$$

The relative angle θ of the mobile platform 20 with respect to the beacon 10, both sides of which are viewed, is expressed by Equation 14.

$$θ = ArcTan [ \frac{- ByDvDv 1 - ByDvDv 2 + 2 BxDv 1 Dv 2}{BxDv ( Dv 1 - Dv 2 )} ] \qquad Equation 14$$

The relative angle θ of the mobile platform 20 with respect to the beacon 10, only one side of which is viewed, is expressed by Equation 15.

$$θ = ArcTan [ \frac{\begin{matrix}- {Bz}^{2} ( ByDv - BxDv 1 ) ( {Dv}^{2} + Dv {1}^{2} ) + \\ ( ByDv ( {Bx}^{2} + {By}^{2} + {Dv}^{2} ) + \\ BxDv ( {Bx}^{2} + {By}^{2} - {Dv}^{2} ) DvH {1}^{2}\end{matrix}}{\begin{matrix}- {Bz}^{2} ( BxDv + ByDv 1 ) ( {Dv}^{2} + Dv {1}^{2} ) + \\ ( BxDv ( {Bx}^{2} + {By}^{2} + {Dv}^{2} ) + \\ ByDv ( {Bx}^{2} + {By}^{2} - {Dv}^{2} ) ) DvH {1}^{2}\end{matrix}} ] \qquad Equation 15$$

Next, an actual application example of the localization system according to the embodiment will be described.

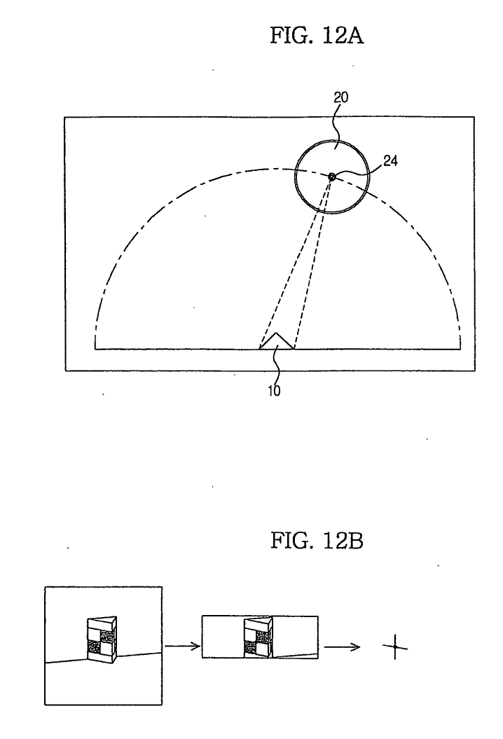

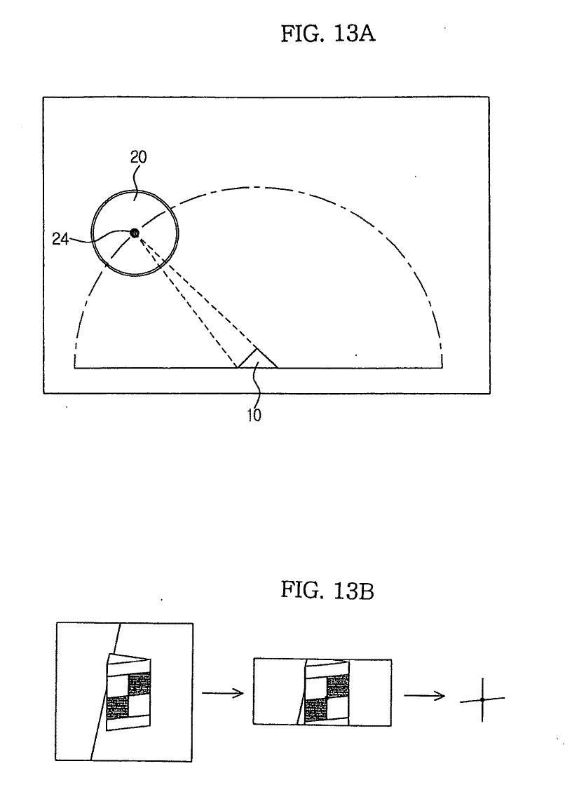

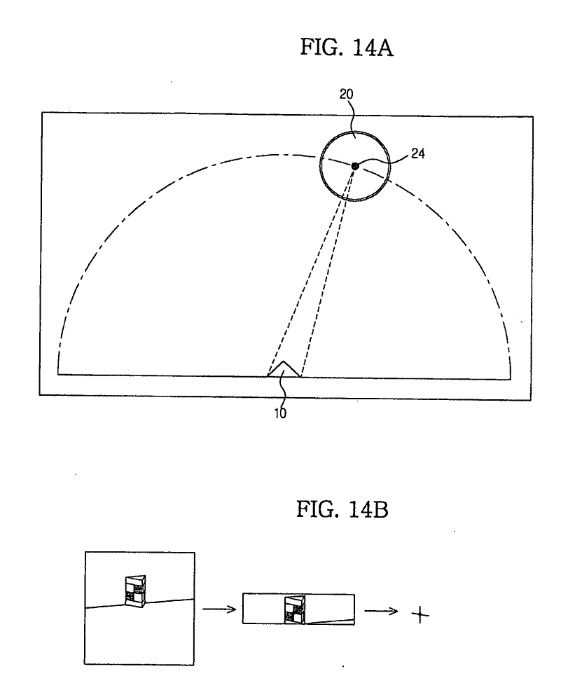

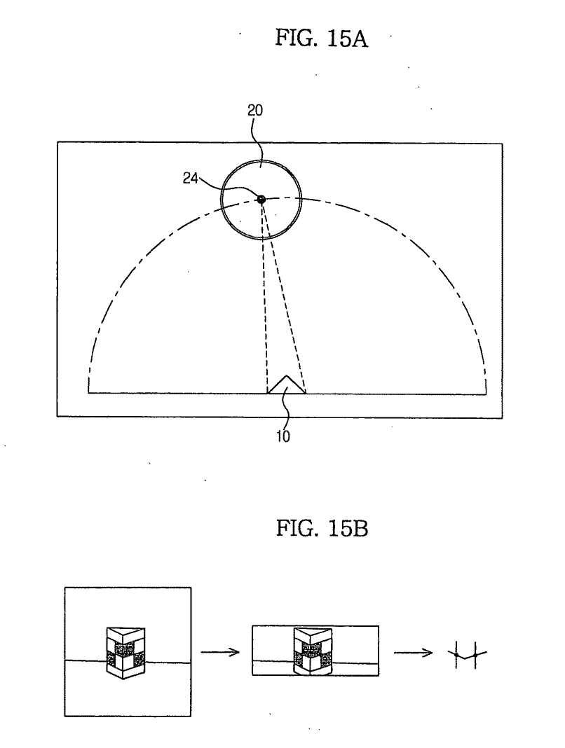

FIGS. 12A to 15B are views showing window images to recognize the location of the mobile platform using the localization system according to the.

In FIGS. 12A to 15B, the horizontal line and the vertical line of a pattern recognition mark “+” respectively indicate the width and the height of the recognized pattern, and each of the window images shows the relative distance and the relative angle of the mobile platform 20 with respect to the triangular beacon 10.

At this time, the relative distance and the relative angle of the mobile platform 20 are converted into a coordinate of the mobile platform 20 and a coverage angle of the mobile platform 20 using a trigonometric function, if necessary.

In the localization system according to the embodiment, the beacon 10 (three-dimensional structure) having the recognizable pattern is disposed at any place in order to recognize the location of the autonomous mobile platform 20, and the relative distance and the relative angle of the mobile platform 20 with respect to the beacon 10 are computed, such that the location of the mobile platform 20 can be accurately recognized. Furthermore, an area may be divided into a predetermined number of small areas and the operation may be performed according to the small areas. If this localization system is applied to a charging station, docking may be realized using image information.

Although the beacon 10 having the recognizable pattern is disposed to be separated from the mobile platform 20 and the image acquisition unit 24 which is the three-dimensional measurement device is attached to the mobile platform 20 in the embodiment, the embodiments are not limited thereto. The same object and effect as the embodiments can be achieved even when the beacon 10 is attached to the mobile platform 20 and the image acquisition unit 24 is disposed to be separated from the mobile platform 20. If the image acquisition unit 24 is disposed to be separated from the mobile platform 20, a communication unit to transmit single image information of the beacon 10 acquired by the image acquisition unit 24 to the mobile platform 20 is separately provided. Any one of an audible frequency signal, an ultrasonic wave, visible light, infrared light, a laser beam, and a Radio Frequency (RF) signal may be used as a signal transmitted by the communication unit.

In addition, although the matching of the pattern using the mask pattern and the check pattern is described as the method of matching the pattern in the embodiment, the embodiments are not limited thereto. A method of matching a feature point of the pattern using Speeded Up Robust Features (SURF) or Scale Invariant Feature Transform (SIFT) may be used.

In addition, although the mobile robot driven by wheels is described as the mobile platform 20 according to the embodiment, the embodiments are not limited thereto. The same object and effect as the embodiments may be achieved even in a bipedal robot driven by legs.

Although a few embodiments have been shown and described, it would be appreciated by those skilled in the art that changes may be made in these embodiments without departing from the principles and spirit of the embodiments, the scope of which is defined in the claims and their equivalents.

What is claimed is:

1. A localization system comprising:
a beacon having a recognizable image pattern; and
a mobile platform, the location of which is recognized using the image pattern of the beacon.

2. The localization system according to claim 1, wherein the beacon is a polygonal structure separated from the mobile platform.

3. The localization system according to claim 2, wherein the polygonal structure further comprises:
at least two sides, and one or more recognizable image patterns printed on the sides.

4. The localization system according to claim 3, wherein the image patterns printed on the sides are the same.

5. The localization system according to claim 1, wherein the mobile platform includes:
an image acquisition unit photographing the beacon and acquiring single image information of the beacon; and
a controller analyzing the acquired single image information and acquiring coordinate information of the location of the mobile platform.

6. The localization system according to claim 5, wherein the acquired coordinate information includes a relative distance and a relative angle of the mobile platform with respect to the beacon.

7. The localization system according to claim 6, wherein the controller measures the height of the recognized pattern in the photographed image and computes the relative distance.

8. The localization system according to claim 6, wherein the controller measures the width of the recognized pattern in the photographed image and computes the relative angle.

9. The localization system according to claim 6, wherein, if one side of the polygonal structure is viewed in the photographed image, the controller compares the heights of the right and left portions of the recognized pattern and computes the relative angle of the mobile platform with respect to the beacon.

10. The localization system according to claim 6, wherein, if two sides of the polygonal structure are viewed in the photographed image, the controller computes the relative angle of the mobile platform with respect to the beacon using a ratio of the widths of the two recognized patterns.

11. The localization system according to claim 5, wherein the mobile platform further includes a storage unit to store geometrical information of the image patterns printed on the sides of the polygonal structure.

12. The localization system according to claim 1, wherein the mobile platform performs an operation in a specific region in which the mobile platform is located with respect to the beacon.

13. The localization system according to claim 1, wherein the beacon is a polygonal structure attached to the mobile platform.

14. The localization system according to claim 13, wherein the polygonal structure comprises at least two sides, and
one or more recognizable image patterns printed on the sides.

15. The localization system according to claim 14, further comprising an image acquisition unit photographing the beacon and acquiring single image information of the beacon,
wherein the image acquisition unit is separated from the mobile platform.

16. The localization system according to claim 15, wherein the mobile platform further includes a controller analyzing the acquired single image information and acquiring coordinate information of the location of the mobile platform.

17. The localization system according to claim 16, wherein the acquired coordinate information includes a relative distance and a relative angle of the mobile platform with respect to the beacon.

18. The localization system according to claim 16, wherein the controller measures the height of the recognized pattern or the beacon in the photographed image and computes the relative distance.

19. The localization system according to claim 16, wherein the controller measures the width of the recognized pattern or the beacon in the photographed image and computes the relative angle.

20. The localization system according to claim 16, wherein, if one side of the polygonal structure is viewed in the photographed image, the controller compares the heights of the right and left portions of the recognized pattern and computes the relative angle of the mobile platform with respect to the beacon.

21. The localization system according to claim 16, wherein, if two sides of the polygonal structure are viewed in the photographed image, the controller computes the relative angle of the mobile platform with respect to the beacon using a ratio of the widths of the two recognized patterns.

22. The localization system according to claim 15, further comprising a communication unit to transmit the acquired single image information to the mobile platform,
wherein the communication unit transmits any one of an audible frequency signal, an ultrasonic wave, visible light, infrared light, a laser beam, or a Radio Frequency (RF) signal.

23. A localization method comprising:
photographing a beacon having a recognizable image pattern and recognizing the image pattern of the beacon;
retrieving candidate patterns from the recognized image pattern using a mask pattern;
extracting a normal pattern from the retrieved candidate patterns using a check pattern;
computing a relative distance and a relative angle of a mobile platform with respect to the beacon using size information of the extracted pattern; and
recognizing the location of the mobile platform using the computed relative distance and relative angle.

24. The localization method according to claim 23, wherein the size information includes at least one of height information of the center of the pattern, vertex information of the right and left portions of the pattern, width information of the right and left portions of the pattern, or combinations thereof.

25. The localization method according to claim 23, further comprising determining the number of sides of the extracted pattern,
wherein the computing of the relative distance and the relative angle includes computing the relative distance using the height of the center of the pattern and computing the relative angle by comparing the heights of the right and left portions of the pattern.

26. The localization method according to claim 23, further comprising determining the number of sides of the extracted pattern,
wherein the computing of the relative distance and the relative angle includes computing the relative distance using the height of the center of the pattern and computing the relative angle using a ratio of the widths of the right and left portions of the pattern.

27. The localization system according to claim 3, wherein the image patterns printed on the sides are different from each other.
